(19) United States
(12) Patent Application Publication
(10) Pub. No.: US 2004/0012193 A1
(43) Pub. Date: Jan. 22, 2004

(54) Method of merchandising

(76) Inventor: Gary Bauman, Ridgewood, NJ (US)

Correspondence Address: JAMES & FRANKLIN, LLP, 60 East 42nd Street, Suite 2915, New York, NY, 10165, US

(21) Appl. No.: 10/195,732

(22) Filed: Jul. 16, 2002

(51) Int. Cl. G09F 1/00

(52) U.S. Cl. 283/56

(57) ABSTRACT

A merchandiser attracts potential customers to its premises by giving away one or more valuable products as prizes to selected customers on its premises. Each customer receives a promotional item associated with the product, either for free, such as upon entering the premises, or with a purchase, at no cost, reduced cost or full cost. Winning items have special indicia entitling the bearer to receive the product prize.

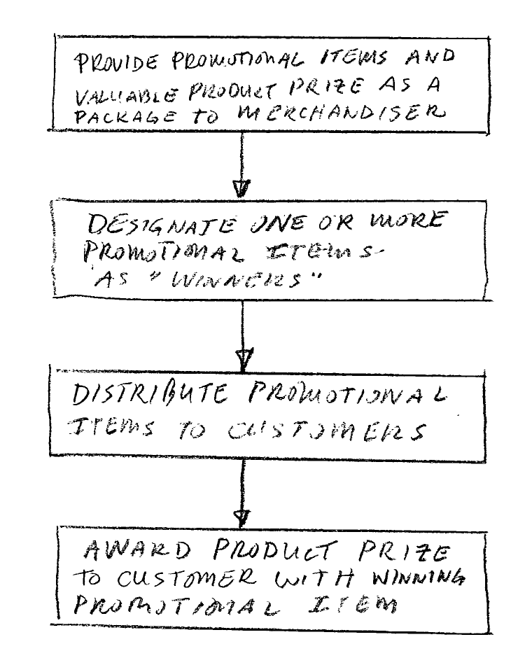

The present invention relates to a method of merchandising and more particularly, a method of attracting potential customers to the premises of a merchandiser.

Merchandisers of all sorts, including department stores, specialty stores, banks, hotels, etc. are always trying to attract potential customers to their premises to increase sales. In the past, this has been done through advertising, sales and promotions of various kinds, including contests and lotteries.

The present invention is a promotional method that involves combining two separate promotional strategies into a single, focused promotional plan designed to elevate the enthusiasm level of the customer and bolster the sales of the merchandiser. It involves distribution of promotional items and conducting a contest for a prize in the form of a valuable product. These two concepts are combined in my merchandising method by selecting the promotional items to be distributed and the product to be given as a prize to be associated with each other.

This approach allows for the price of the product to be given away to be amortized into the price of the promotional items. The opportunity to win a significant prize as well as to obtain a complimentary promotional item at no cost or at reduced cost provides the merchandiser's customers with an enticing reason to visit or shop with the merchandiser. The merchandiser is able to run a promotion featuring a lower value promotional item that has its perceived value enhanced by the potential customers' notion that they have a chance to win a valuable prize.

It is, therefore, a prime object of the present invention to provide a method of merchandising involving a contest to win a prize in the form of a valuable product in conjunction with the distribution of product associated promotional items.

It is another object of the present invention to provide a method of merchandising directed at elevating the level of enthusiasm of the potential customer and bolstering sales of the merchandiser.

In accordance with the present invention, a method of merchandising is provided for a merchandiser that desires to attract potential customers to its premises. The method includes providing a prize in the form of a valuable product to the merchandiser. A number of promotional items associated with the product are also provided to the merchandiser. At least one of the product associated promotional items is designated with a special indicia. The product associated promotional items are distributed to potential customers, preferably at the premises of the merchandiser. The customer having the special indicia bearing product associated promotional item is given the product.

The items may be distributed to the customers with or without a purchase. They may be distributed to potential customers at full cost, reduced cost or no cost.

For example, the promotional items may be key chains. The indicia may be an ignition key attached to one of the chains. The product may be a car which the ignition key on the chain starts.

In another example, the promotional items may be cameras with loaded film. The product may be a valuable object. The indicia may be a pre-exposed picture of the object on the film.

In another example, the promotional items may be CD cases. The product may be a CD player. The indicia may be a voucher situated within the “winning” CD cases.

To these and such other objects which may hereinafter appear, the present invention relates to a method of merchandising as set forth in detail in the following specification, recited in the annexed claims and illustrated in the accompanying drawing.

As illustrated in the drawing, the present invention relates to a method of merchandising in which a complete “turnkey” promotional package is provided to a merchandiser. The package includes a plurality of relatively low priced promotional items and one or more valuable products to be used as prizes.

The promotional items and the prizes are associated with each other in some way, such as visually or mechanically. One or more of the promotional items are designated as “winners” by being different from the other promotional products in some obvious way, such as including a “winning” indicia.

The promotional products are distributed to customers, preferably at the premises of the merchandiser. They can be distributed without the necessity of a purchase, for example, as the customer enters the premises, at no cost, reduced cost or full cost. Alternatively, the promotional items may be distributed in conjunction with a purchase, at no cost, reduced cost or full cost.

The customer or customers who receive the promotional items that have been designated as “winners” receive the prize. The program attracts customers to the merchandiser and builds good will with the customer who receives the promotional item and a chance to win a valuable product prize.

To best understand the method of the invention, the following examples are provided. In the first example, the package includes 100,000 key chains as promotional items. The prize offered is a classic automobile. The promotional item and the prize are sold to the merchandiser as a package. The merchandiser, in turn, offers each of its customers a key chain as a free giveaway, upon entering the premises. Through a random selection process in a controlled environment, one of the client's customers receives a key chain with an ignition key attached. That key starts the car. The lucky customer with the ignition key wins a valuable automobile, along with his/her key chain.

In a second example, the package sold to the merchandiser includes 100,000 cameras with film. The prize is a high quality jewelry piece. The merchandiser offers each of its customers a camera at reduced cost with the purchase of another item. One pre-selected camera is specially fitted with a pre-exposed picture of the jewelry piece. The customer with the picture of the jewelry piece has won the jewelry piece.

In a third example, the package sold to the merchandiser that includes 100,000 CD cases and 200 CD player prizes. The merchandiser offers each of its customers a CD case at a cost of ten cents when they purchase another item. 200 of the CD cases have vouchers inside alerting customer that they have won a CD player.

While only a single preferred embodiment of the present invention has been disclosed for purposes of illustration, it is obvious that many variations and modifications could be made thereto. It is intended to cover all of these variations and modifications which fall within the scope of the invention, as defined by the following claims:

I claim:

1. A method of merchandising permitting a merchandiser to attract potential customers to its premises, the method comprising the steps of:
(a) providing a valuable product prize to the merchandiser;
(b) providing a number of promotional items which are associated with the product to the merchandiser;
(c) designating at least one of the product associated promotional items with a special indicia;
(d) distributing the product associated promotional items to customers of the merchandiser; and
(e) giving the product to the customer having the special indicia bearing product associated promotional item.

2. The method of claim 1 wherein the items are distributed to customers with a purchase.

3. The method of claim 1 wherein the promotional items are distributed to customers at reduced cost.

4. The method of claim 1 wherein the promotional items are distributed to customers at full cost.

5. The method of claim 1 wherein the potential items are distributed to customers at no cost.

6. The method of claim 2 wherein the promotional items are distributed to customers at reduced cost.

7. The method of claim 2 wherein the promotional items are distributed to customers at full cost.

8. The method of claim 2 wherein the promotional items are distributed to customers at no cost.

9. The method of claim 1 wherein the product prize and product associated promotional items are provided to the merchandiser as a package.

10. The method of claim 1 wherein the promotional items are key chains, the indicia is an ignition key attached to one of the chains, and the product prize is the car which the ignition key on the chain starts.

11. The method of claim 1 wherein the promotional items are cameras with film, the product prize is an object and the indicia is a pre-exposed picture of the object.

12. The method of claim 1 wherein the promotional items are CD cases, the product is a CD player and the indicia is a voucher situated in one of the CD cases indicating that the holder of the case is the winner.
